(19) United States
(12) Patent Application Publication
(10) Pub. No.: US 2003/0046033 A1
(43) Pub. Date: Mar. 6, 2003

(54) Electronic detection method having system-identifying function and device thereof

(76) Inventors: Yuan-Jung Chang, Hsinchuang City (TW); Chun-Wei Kao, Chungho City (TW); Chia-Ming Chung, Sanchung City (TW); Shyhjir Ferng, Hsintien City (TW); Chien-Kun Liao, Panchiao City (TW); Bee Yeong Khoo, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/006,161

(22) Filed: Dec. 10, 2001

(30) Foreign Application Priority Data
Aug. 29, 2001 (TW) 90121253

(51) Int. Cl. G06F 11/00

(52) U.S. Cl. 702/188

(57) ABSTRACT

The present invention proposes an electronic detection method having system-identifying function and a device thereof. The device comprises a data record device comprising a data storage unit, an equipment-end data transmission unit, a central processing unit, and a data conversion unit and a remote-end detection device comprising a detection-end data transmission unit, a data register unit, a central processing unit, and a data display unit. A data connection line, infrared transmission modules, or wireless transmission modules can be used as transmission media between the data record device and the remote-end detection device. The method comprises the steps of: storing basic data of an electrical equipment into the data record device, using the equipment-end data transmission unit to transmit the basic data to the detection-end data transmission unit, using the data display unit to display the basic data, or transmitting the basic data to a computer for subsequent processing.

### FIELD OF THE INVENTION

The present invention relates to an electronic detection method having system-identifying function and a device thereof and, more particularly, to a method and a device capable of storing data of hardware devices, software categories, and operational statues used in an electrical equipment and using a remote-end detection device to read out the data.

### BACKGROUND OF THE INVENTION

Basic data or internal hardware and software data of all present electrical equipments (including electrical appliances such as televisions, refrigerators, and air conditioners, computer equipments such as desktop computers, notebook computers, handheld computers, and personal digital assistants, and computer peripherals such as printers, scanners, and digital cameras) are recorded in technical manuals or maintenance manuals that users should properly keep. The data include basic data and internal hardware and software data of electrical equipments, and specification data of normal use or operation. Contents of the data include brand names, types, serial numbers, check codes, functions, suppliers, dates, regions, and countries of production, technical manuals, maintenance manuals, and warranty data, and also include physically measurable values such as voltages, currents, powers, frequencies, temperatures, humidities, speeds, heights, rotation speeds, or luminosities. If it is necessary to build inventories for electrical equipments, ways such as typing, etching, sand spraying, and pasting labels, bar codes, or metal plates are generally used. However, the labels may drop or disappear, or the types may be blurry and unidentifiable or may be counterfeited after a period of time. If the electrical equipments are company's assets, they need to be checked once a year or half a year. The above ways usually bring about trouble of check men or the drawback of being unable to accurately check.

Additionally, when the equipments malfunction and need to be troubleshot, or need to be maintained, it is necessary for users or maintenance men to find out technical manuals or warranties of the electrical equipments, or to detach housings thereof so as to know basic data such as software and hardware of the electrical equipments for maintenance and troubleshooting. If there is a device capable of automatically detecting basic data of electrical equipments and utilizing a remote-end device to directly read out basic data of the electrical equipments, much time of check men and maintenance and troubleshooting men can be saved.

Accordingly, the present invention aims to propose an electronic detection method having system-identifying function and a device thereof capable of automatically transmitting basic data and operation and status data of electrical equipments to a remote-end detection device so that a user can know the basic data of the electrical equipments without the need of looking up technical manuals or detaching housings thereof, thereby facilitating check, troubleshooting, or maintenance.

### SUMMARY OF THE INVENTION

The primary object of the present invention is to provide an electronic detection method having system-identifying function and a device thereof capable of storing basic data and operational status data in an electrical equipment to always accompany the electrical equipment so that the data will not disappear or become blurry as time goes by.

The secondary object of the present invention is to provide an electronic detection method having system-identifying function and a device thereof so that maintenance and troubleshooting men or check men can immediately achieve connection with an electrical equipment via a remote-end device to automatically receive basic data and operational status data of the electrical equipment when the electrical equipment malfunctions and needs to be troubleshot or needs to be checked routinely, thereby facilitating maintenance, troubleshooting, or check.

Another object of the present invention is to provide an electronic detection method having system-identifying function and a device thereof capable of inputting the buyer's or user's data into an electrical equipment when the electrical equipment leaves the factory or is sold out, thereby securing legal usage and justifiability of the user, i.e., providing a usage certificate of the electrical equipment.

The present invention is characterized in that an electronic detection device having system-identifying function is provided. The electronic detection device having system-identifying function comprises a data record device disposed at an electrical equipment end and a remote-end detection device. The data record device comprises a data storage unit for storing basic data and operational status data of the electrical equipment, an equipment-end data transmission unit for transmitting data in the data storage unit to the remote-end detection device, a central processing unit for controlling operational flows of the data storage unit and the equipment-end data transmission unit, and a data conversion unit for converting data in the data storage unit to facilitate storage or transmission of data. The remote-end detection device comprises a detection-end data transmission unit for receiving data transmitted from the data record device, a data register unit for temporarily storing data transmitted from the data record device for subsequent processing, a central processing unit for controlling operational flows of the detection-end data transmission unit and the data register unit, and a data display unit for displaying detected data in texts or pictures.

The various objects and advantages of the present invention will be more readily understood from the following detailed description when read in conjunction with the appended drawing, in which:

### BRIEF DESCRIPTION OF THE DRAWINGS

FIG. 1 is an architecture diagram of an electronic detection device having system-identifying function of the present invention;

FIGS. 2A, 2B, and 2C are diagrams showing data transmission between a data record device and a remote-end detection device of the present invention;

FIG. 3 is a diagram showing the steps of an electronic detection method having system-identifying function of the present invention; and

FIG. 4 is a diagram showing the renewal steps of basic data of an electrical equipment of the present invention.

### DETAILED DESCRIPTION OF THE PREFERRED EMBODIMENTS

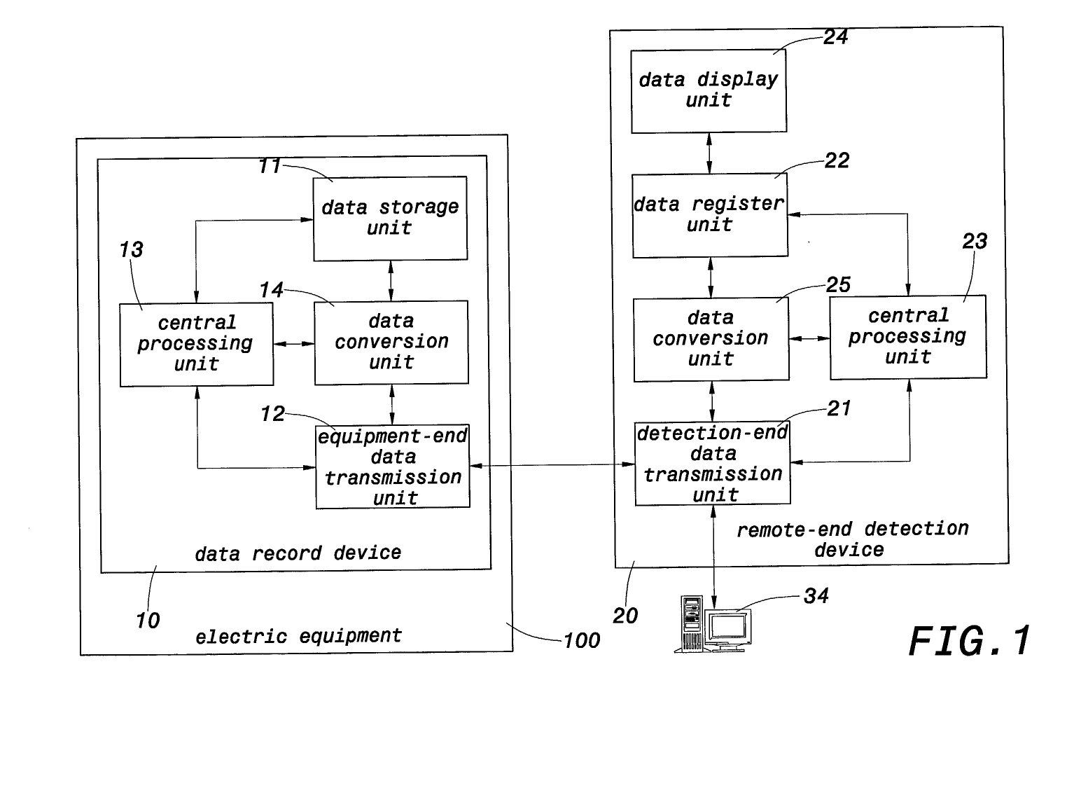

As shown in FIG. 1, the present invention provides a device for detecting and managing basic data of all electrical equipments. The device uses a data record device 10 disposed at an electrical equipment 100 to record basic data of the electrical equipment 100 in advance, and then uses a remote-end detection device 20 to read out the basic data of the electrical equipment 100. The data record device 10 comprises a data storage unit 11, an equipment-end data transmission unit 12, a central processing unit 13, and a data conversion unit 14. The remote-end detection device 20 comprises a detection-end data transmission unit 21, a data register unit 22, a central processing unit 23, a data display unit 24, and a data conversion unit 25. The central processing unit 13 of the data record device 10 is used as a control center of the data record device 10 to control operational flows of the data storage unit 11 and the equipment-end data transmission unit 12. The data storage unit 11 is used to store basic data such as hardware and software information and system information and operational status data. The data storage unit 11 uses a storage medium composed of nonvolatile memory device such as an electrically erasable programmable read only device (EEPROM), a flash memory, a disk, a tape, a CD/DVD, or a portable flash storage medium such as a CF card, a SM card, a Secure Digital, a Multi Media Card, a Memory Stick, or a Memory Stick Duo. The equipment-end data transmission unit 12 is used to transmit data in the data storage unit 11 to the remote-end detection device 20, or to receive data transmitted from the remote-end detection device 20. The data conversion unit 14 is used to convert data in the data storage unit 11 for further transmission or storage, e.g., converting data in the data storage unit 11 from digital data into text data or vice versa, compressing or uncompressing data, or encoding or decoding data, thereby ensuring safety of data, shrinking storage space, or shortening transmission time.

The central processing unit 23 in the remote-end detection device 20 is used as a control center of the remote-end detection device 20 to control operational flows of the detection-end data transmission unit 21 and the data register unit 22. The data transmission 21 of the remote-end detection device 20 is used to receive data transmitted from the data record device 10, or to transmit renewal data of the remote-end detection device 20 to the data record device 10. When the remote-end detection device 20 receives data transmitted from the data record device 10, the data conversion unit 25 first performs conversion of data (e.g., conversion between digital data and text data, compression/uncompression, or encoding/decoding), and the data display unit 24 displays the data in texts or pictures. The remote-end detection device 20 can also temporarily store data into the data register unit 22 until a user transmits the data to another equipment or a computer 34 via the detection-end data transmission unit 21 for further processing or management.

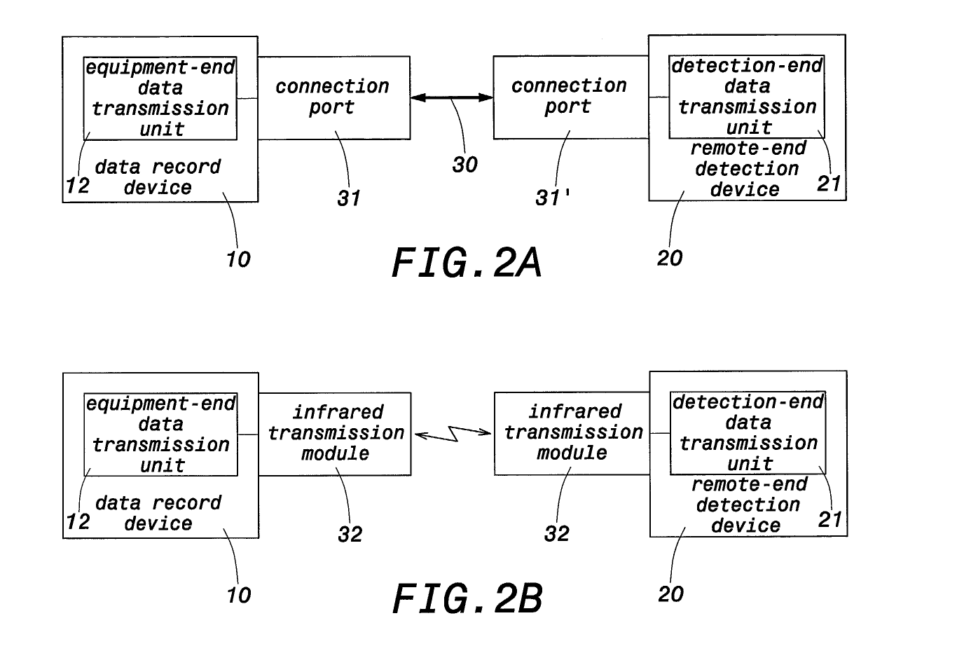

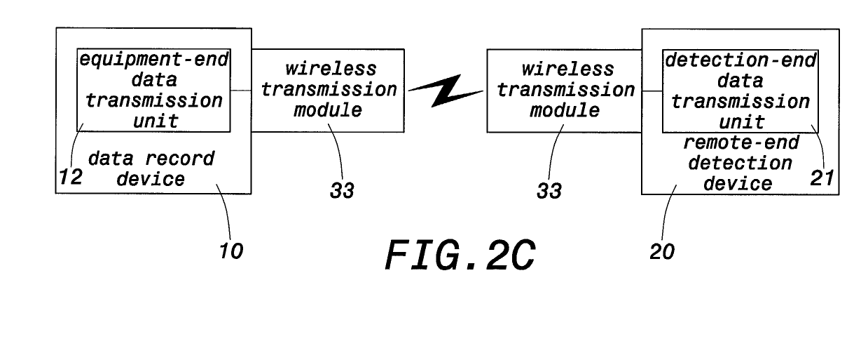

As shown in FIGS. 2A, 2B, and 2C, a data connection line 30 can be used between the equipment-end data transmission unit 12 of the data record device 10 and the detection-end data transmission unit 21 of the remote-end detection device 20 for transmission of data between them (as shown in FIG. 2A), and connection ports 31 and 31′ are respectively disposed on the data record device 10 and the remote-end detection device 20 to facilitate connection of the data connection line 30. The present invention can also use wireless transmission technique for transmission. As shown in FIG. 2B, infrared transmission modules 32 are used to transmit data between the data record device 10 and the remote-end detection device 20. The infrared transmission technique can be optical communication technique such as IR, IrDA, or laser light. As shown in FIG. 2C, wireless transmission modules 33 are used to transmit data between the data record device 10 and the remote-end detection device 20. The wireless transmission module 33 can be wireless communication technique such as bluetooth, 802.11x, Home RF, or HIPER Lan.

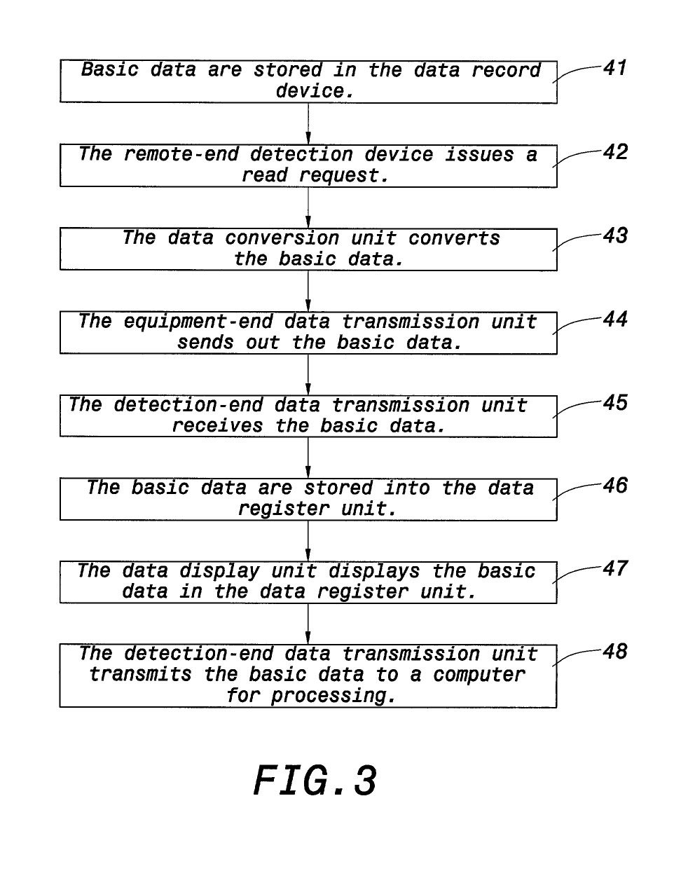

As shown in FIG. 3, an electronic detection method having system-identifying function of the present invention comprises the following steps.

Step 41: Basic data of the electrical equipment 100 are stored into the data record device 10 in advance;

Step 42: The remote-end detection device 20 issues a read request;

Step 43: The data conversion unit 14 of the data record device 10 converts the basic data between digital data and text data, compress or uncompress the basic data, or encode or decode the basic data;

44: The equipment-end data transmission unit 12 of the data record device 10 sends out the basic data;

45: The detection-end data transmission unit 21 of the remote-end detection device 20 receives the basic data;

46: The received basic data are stored into the data register unit 22 of the remote-end detection unit 20;

47: The data display unit 24 of the remote-end detection device 20 displays the basic data in the data register unit 22;

48: The detection-end data transmission unit 21 of the remote-end detection device 20 transmits the basic data to a computer for subsequent processing.

In the above Step 41, the basic data of the electrical equipment 100 are stored into the data record device 10 in advance. The basic data can be product data of the electrical equipment 100 itself, or internal hardware data of the electrical equipment 100 including names, items, types, serial numbers, check codes, functions, suppliers, dates, regions, and countries of production, technical manuals, maintenance manuals, and warranties. The basic data can also be all internal software data including software items, names, types, serial numbers, check codes, functions, suppliers, date of purchase, languages, regions, countries, technical manuals, and warranties. With a computer as an example, the hardware can comprise a CPU, RAM modules, chip sets, a motherboard, hard disks, optical disk drives, a sound card, and a display card, and the software can comprise operation systems such as Windows, text processors such as Word and Excel, web browsers such as Internet Explorer, compression programs such as WinZip, and media playing programs such as Media Player. Additionally, the basic data can also be operational status data of the electrical equipment 100 including physically measurable values of normal usage or operation such as voltages, currents, powers, frequencies, temperatures, humidities, speeds, heights, rotation speeds, or luminosities, e.g., the working voltage, current, power, temperature, and humidity of a refrigerator.

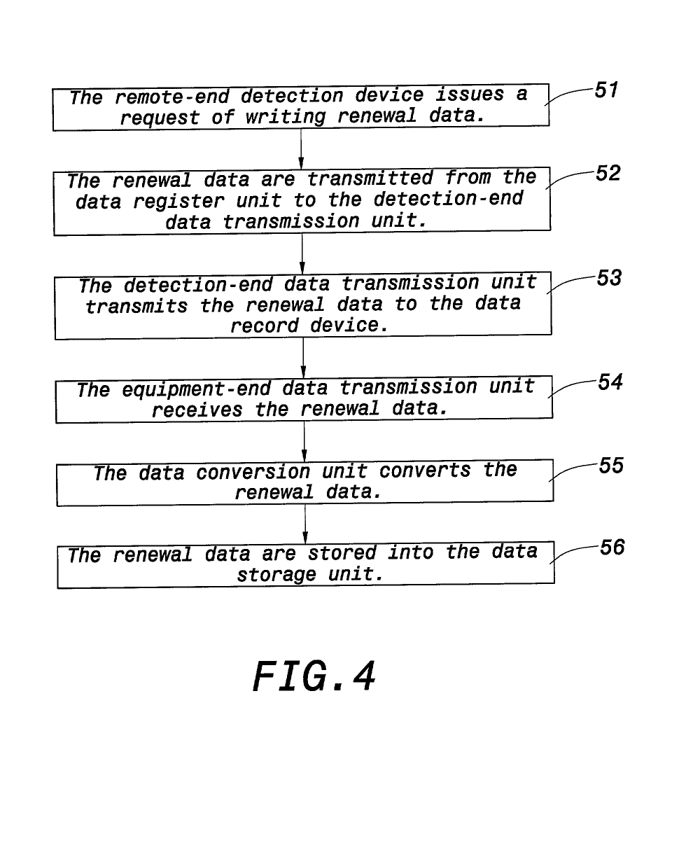

As shown in FIG. 4, because internal software or hardware subassemblies of the electrical equipment 100 can be renewed or modified due to maintenance or upgrade, the present invention can use the remote-end detection device 20 to transmit the renewed data back to the data record device 10 so that the renewed data can always accompany the electrical equipment 100. Renewal of the basic data of the electrical equipment 100 of the present invention comprises the following steps.

Step 51: The remote-end detection device 20 issues a request of writing renewal data;

52: The remote-end detection device 20 transmits the renewal data from the data register unit 22 to the detection-end data transmission unit 21;

53: The detection-end data transmission unit 21 of the remote-end detection device 20 transmits the renewal data to the data record device 10;

54: The equipment-end data transmission unit 12 of the data record device 10 receives the renewal data;

55: The data conversion unit 14 of the data record device 10 converts the renewal data between digital and text data, compresses or uncompresses the renewal data, or encodes or decodes the renewal data;

56: The data record device 10 stores the renewal data into the data storage unit 11.

To sum up, the electronic detection method having system-identifying function and the device thereof of the present invention is characterized in that:

1. The present invention can store basic data and operational status data of an electrical equipment therein to always accompany the electrical equipment so that the data will not disappear or become blurry as time goes by.

2. The present invention can let maintenance and troubleshooting men or check men to immediately achieve connection with an electrical equipment via a remote-end device to automatically receive basic data and operational status data of the electrical equipment when the electrical equipment malfunctions and needs to be troubleshot or needs to be checked routinely, thereby facilitating maintenance, troubleshooting, or check.

3. The present invention can input the buyer's or user's data into an electrical equipment when the electrical equipment leaves the factory or is sold out, thereby securing legal usage and justifiability of the user, i.e., providing a usage certificate of the electrical equipment.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An electronic detection device having system-identifying function used to detect basic data of an electrical equipment, said electronic detection device comprising a data record device disposed at said electrical equipment and a remote-end detection device; said data record device comprising:
a data storage unit used to store basic data such as software and hardware information and system information and operational status data of said electrical equipment; and
an equipment-end data transmission unit used to transmit data in said data storage unit to said remote-end detection device, or to receive data transmitted from said remote-end detection device; said remote-end detection device comprising:
a detection-end data transmission unit used to receive data transmitted from said data record device or to transmit renewal data to said data record device; and
a data register unit used to temporarily store data transmitted from said data record device for subsequent processing.

2. The electronic detection device as claimed in claim 1, wherein said data record device further comprises a central processing unit used as a control center of said data record device to control operational flows of said data storage unit and said equipment-end data transmission unit.

3. The electronic detection device as claimed in claim 1, wherein said data record device further comprises a data conversion unit used to convert digital data in said data storage unit into text data or vise versa, to compress or uncompress data, or to encode or decode data, thereby facilitating storage or transmission of data.

4. The electronic detection device as claimed in claim 1, wherein said remote-end detection device further comprises a central processing unit used as a control center of said remote-end detection device to control operational flows of said detection-end data transmission unit and said data register unit.

5. The electronic detection device as claimed in claim 1, wherein said remote-end detection device further comprises a data display unit used to display detected data in texts or pictures.

6. The electronic detection device as claimed in claim 1, wherein said remote-end detection device further comprises a data conversion unit used to convert digital data in said data storage unit into text data or vise versa, to compress or uncompress data, or to encode or decode data, thereby facilitating storage or transmission of data.

7. The electronic detection device as claimed in claim 1, wherein said detection-end data transmission unit of said remote-end detection device can transmit data in said data register unit to another equipment or a computer for subsequent processing.

8. The electronic detection device as claimed in claim 1, wherein a data connection line is used as transmission medium of data between said equipment-end data transmission unit and said detection-end data transmission unit.

9. The electronic detection device as claimed in claim 1, wherein infrared transmission modules or optical communication techniques are used as transmission media of data between said equipment-end data transmission unit and said detection-end data transmission unit.

10. The electronic detection device as claimed in claim 1, wherein wireless transmission modules or wireless communication techniques are used as transmission media of data between said equipment-end data transmission unit and said detection-end data transmission unit.

11. The electronic detection device as claimed in claim 1, wherein said data storage unit is made of nonvolatile memory device.

12. An electronic detection method having system-identifying function, which uses a data record device disposed at an electrical equipment to record basic data of said electrical equipment and a remote-end detection device to retrieve said basic data, said method comprising the steps of:
storing said basic data of said electrical equipment into said data record device in advance;
sending out said basic data by said equipment-end data transmission unit of said data record device;
receiving said basic data by said detection-end data transmission unit of said remote-end detection device; and
temporarily storing said received basic data into said data register unit by said remote-end detection device.

13. The electronic detection method as claimed in claim 12 further comprising the step of displaying said basic data in said data register unit by said data display unit.

14. The electronic detection method as claimed in claim 12 further comprising the step of transmitting said basic data to a computer for subsequent processing by said detection-end data transmission unit.

15. The electronic detection method as claimed in claim 12 further comprising the step of converting said basic data into digital or text data for transmission.

16. The electronic detection method as claimed in claim 15, wherein said data conversion step performed by said data conversion unit compresses or uncompresses data, or encodes or decodes data.

17. An electronic detection method having system-identifying function, wherein renewal of basic data of an electrical equipment comprising the steps of:
issuing a request of writing renewal data by a remote-end detection device;
transmitting said renewal data to a data record device by a detection-end data transmission unit of said remote-end detection device;
receiving said renewal data by an equipment-end data transmission unit of said data record device; and
storing said renewal data into a data storage unit.

18. The electronic detection method as claimed in claim 17 further comprising the step of transmitting said renewal data from a data register unit to said detection-end data transmission unit by said remote-end detection device.

19. The electronic detection method as claimed in claim 17 further comprising the step of converting said renewal data into digital or text data by said data conversion unit and then storing into said data storage unit.

20. The electronic detection method as claimed in claim 17, wherein said data conversion step performed by said data conversion unit compresses or uncompresses data, or encodes or decodes data.
